(19) United States
(12) Patent Application Publication
(10) Pub. No.: US 2025/0264330 A1
(43) Pub. Date: Aug. 21, 2025

(54) Method and Apparatus for Assigning a Specific Reagent to a Reaction Space

(71) Applicant: Robert Bosch GmbH, Stuttgart (DE)

(72) Inventor: Daniel Sebastian Podbiel, Rutesheim (DE)

(21) Appl. No.: 18/257,394

(22) PCT Filed: Dec. 7, 2021
(86) PCT No.: PCT/EP2021/084529

§ 371 Date: Oct. 30, 2023

(30) Foreign Application Priority Data
Dec. 16, 2020 (DE) 10 2020 215 979.3

(51) Int. Cl. G01B 21/04

(52) U.S. Cl. CPC G01B 21/04

(57) ABSTRACT

A method for assigning at least one specific reagent to a reaction space of a carrier device for the processing of a substance within a microfluidic analysis system includes: reading in a spatial pattern arrangement of the reaction spaces on the carrier device, at least a first reaction space assigned a first specific reagent and a second reaction space assigned a second specific reagent; determining a starting reaction space to which a specific reagent has not yet been assigned; measuring a first and second spatial distances, respectively, between the starting reaction space and the first and second reaction spaces; and defining the first specific reagent as the specific reagent of the starting reaction space if the first distance is greater than the second distance and/or defining the second specific reagent as the specific reagent of the starting reaction space if the second distance is greater than the first distance.

### THE PRIOR ART

The invention proceeds from an apparatus or method used for assigning a specific reagent to a reaction space according to the type of invention specified in the independent claims. The object of the present invention is also a computer program.

Microfluidic analysis systems, which can also be referred to as lab-on-chips (abbreviated as LoCs), enable automated, reliable, compact and cost-effective processing of chemical or biological substances for medical diagnostics. For example, when performing molecular diagnostic tests that examine a sample for a plurality of different features, also known as targets, analyses are often performed in array format to enable parallelized examination of a sample. In order to achieve a particularly high reliability of the sample analysis, a redundant design of such arrays is recommended, in which several detection spots of the array are used for the detection of the same target.

### DISCLOSURE OF THE INVENTION

Against this background, the approach presented herein introduces an improved method for assigning a specific reagent to a reaction space, a carrier device with at least one reagent assigned according to the method, furthermore an apparatus using this method, and finally a corresponding computer program according to the main claims. Advantageous embodiments of and improvements to the apparatus specified in the independent claim are made possible by the measures specified in the dependent claims.

For example, the method can be applicable in the context of a microfluidic apparatus device using an array of reaction spaces present at predefined positions, which can also be referred to as detection spots. A particularly advantageous assignment of a predetermined plurality of specific reagents, which are also referred to as target reagents and can in this case be used for the specific detection of features of a sample (targets), to the reaction spaces is possible in order to optimize redundant detection of the features of a sample addressed by means of the specific reagents. The method can advantageously be applied to arrays designed in any desired manner, i.e., spatial arrangements of the reaction spaces designed in any desired manner in order to achieve a particularly advantageous assignment of the reaction spaces to the specific reagents for the specific detection of features of a sample (targets), e.g. target molecules. For example, arrays having a regular or irregular arrangement of reaction spaces can be used. As a result, the method can be applied in a particularly versatile manner to arrays of different design.

Presented is a method for assigning at least one specific reagent to at least one reaction space of a carrier device for the processing of a substance within a microfluidic analysis system, the method comprising the following steps:
reading in a spatial pattern arrangement of the reaction spaces on the carrier device, at least a first reaction space having been assigned a first specific reagent and a second reaction space having been assigned a second specific reagent,
determining a starting reaction space to which a specific reagent has not yet been assigned,
measuring a first spatial distance between the starting reaction space and the first reaction space and a second spatial distance between the starting reaction space and the second reaction space, and
defining the first specific reagent as the specific reagent of the starting reaction space if the first distance is greater than the second distance and, additionally or alternatively, determining the second specific reagent as the specific reagent of the starting reaction space if the second distance is greater than the first distance.

The carrier device can, e.g., be a microfluidic analysis cartridge that can be used to analyze various samples, e.g. in medical diagnostics. For this purpose, the carrier device can, e.g., comprise a microarray on which various reaction spaces, which can also be referred to as detection spots and can be arranged according to a predefined spatial pattern. The reaction spaces can, e.g., be microfluidic reaction compartments with upstream reagents for the detection of different features (targets), e.g., nucleic acids with a defined base sequence in a sample fluid. Alternatively, the reaction spaces can be capture molecules immobilized on a surface, which can be used for specific detection of targets in a sample fluid. For example, the lateral dimension of a reaction space can be between 200 μm and 500 μm. For example, the reaction spaces can in this case be arranged on a circular surface according to a hexagonal scheme, thus forming the array in its entirety. The array can, e.g., be used in lab-on-chip systems in the field of molecular laboratory diagnostics. The sample can be analyzed using such or similar pattern arrangement, e.g., for a plurality of different features (targets, target molecules) of the sample. The features can, e.g., be deoxyribonucleic acids which have, e.g., been extracted from sample material and are of diagnostic, clinical, or therapeutic relevance. When analyzing the sample, different specific reagents can be assigned to different reaction spaces to detect predetermined characteristics of the sample. For example, following the assignment at the different reaction spaces, different reactions can therefore be performed to detect the corresponding features. For example, detection of the features can be performed by an amplification reaction such as a polymerase chain reaction or using an isothermal amplification method or by a hybridization reaction. The evaluation of the detection spots for the detection of the features/targets can be performed, e.g., by fluorescence or chemiluminescence measurements.

During the course of the method presented herein, a pattern arrangement is read in, and a specific reagent for the detection of at least one feature is assigned to each of the reaction spaces. In particular, an assignment can in this case also comprise an arrangement or placement of the specific reagent on the assigned reaction space. The desired number of features to be detected can, e.g., have already been determined before the pattern arrangement is read in. In order to optimize an even distribution of the features among the reaction spaces of the pattern arrangement, a starting reaction space is determined to which no specific reagent has yet been assigned, and then the first spatial distance between the starting reaction space and the first reaction space already occupied by a specific reagent are measured, as well as the second distance between the starting reaction space and the second reaction space also occupied by a specific reagent. The difference in size between the first distance and the second distance can be used to determine which specific reagent is closest to the starting reaction space. Based on this information, the specific reagent that is the furthest away from the starting reaction space can be defined as the specific reagent for the starting reaction space. Advantageously, the specific reagents can thus be spatially assigned as uniformly as possible to the reaction spaces of the pattern arrangement, whereby a particularly high degree of redundancy can be achieved for the detection of features of a sample addressed by the specific reagents.

According to one embodiment, a spatial pattern arrangement in which a third specific reagent has been assigned to a third reaction space can be read in during the reading in step. Moreover, during the measurement step, a third spatial distance between the starting reaction space and the third reaction space can additionally be compared with the second distance and the first distance and, during the defining step, the third specific reagent can be defined as a specific reagent of the starting reaction space if the third distance is greater than the second distance and the first distance. For example, the number of specific reagents can have already been determined to three prior to the reading in step. Accordingly, the three specific reagents can have been assigned to three different reaction spaces. In order to optimize the distribution of the specific reagents in the pattern arrangement, the first distance can be compared with the second distance and the third distance in order to define the specific reagent of the starting reaction space. The specific reagent for the starting reaction space having the largest distance to the starting reaction space can then be selected. According to such a procedure, four or more specific reagents can also be determined in advance of the method and assigned to the reaction spaces during the course of the method. Advantageously, any desired number of specific reagents can be optimally distributed and a particularly high degree of redundancy can be achieved overall for the detection of the features performed by means of the specific reagents.

According to a further embodiment, different specific reagents can each be assigned to a reaction space prior to the reading in step. For example, prior to the reading in step, any desired number n of the specific reagents tⱼ to be distributed can be determined, where j can correspond to an integer or whole number of ordinal digits. For example, the number n of specific reagents to be distributed can be determined at 9. Accordingly, each reaction space of the pattern arrangement can also be assigned an integer or ordinal number within the interval [1, N]. For example, the pattern arrangement can comprise an array of 150 reaction spaces, whereby each reaction space can be assigned an ordinal number between 1 and 150. The reaction spaces with the smallest ordinal numbers, e.g., in the vicinity of the origin of the coordinate system and optionally in the central area of the array, can, e.g., be assigned the nine specific reagents in any desired order. Advantageously, after determining the desired number of specific reagents and assigning them to a corresponding number of reaction spaces, the previously described method can be optimally applied and implemented.

Alternatively, several specific reagents can be assigned to each reaction space or one specific reagent can be designed to address several sub-targets or sub-features that can be detected. In this way, the pattern arrangement can also be particularly suitable for an implementation of multiplex detections in each case, which can be assigned to the reaction spaces.

According to a further embodiment, before the reading in step, a specific reagent can be assigned to a reaction space which is at a greater distance from an edge region of the pattern arrangement than another reaction space. For example, the pattern arrangement can be arranged according to a Cartesian coordinate system, defined with a predetermined origin, such as the center of the array. Different specific reagents can in this case be assigned to a plurality of reaction spaces starting from the specified origin. Especially in the case of an approximately circular or hexagonal pattern arrangement, such a procedure has the advantage that the assignment of specific reagents to reaction spaces that are still free can be performed in an almost spiral fashion, thus avoiding gaps or overlaps during the assignment.

In addition, the steps of the method can be repeated for a further starting reaction space other than the starting reaction space. For example, during the determination step, another starting reaction space can be determined that does not yet have a specific reagent assigned to it. Subsequently, a first spatial distance between the further starting reaction space and the first reaction space and a second spatial distance between the further starting reaction space and the second reaction space can be measured, as well as a further spatial distance between the starting reaction space and the further starting reaction space. During the defining step, the first specific reagent can, e.g., be defined to be the specific reagent of the further starting reaction space if the first distance is greater than the second distance and the further distance. Advantageously, the steps of the method can be repeated in this way until each reaction space is occupied. In addition, the repeated performance of the method has the advantage that an evaluation of a given, in particular contiguous, subsection of the pattern arrangement can already be sufficient to enable detection of all features (targets, target molecules) of the sample addressed by means of the specific reagents and additionally or alternatively to achieve a particularly high degree of redundancy for the detection of all features of the sample.

According to a further embodiment, a polar angle of the position of the starting reaction space in a selected polar coordinate system having an origin at the center of the pattern arrangement can be smaller than a polar angle of the position of the further starting reaction space with respect to the selected polar coordinate system having an origin at the center of the pattern arrangement. In particular, a polar angle of the position of another starting reaction space with respect to the selected polar coordinate system having an origin at the center of the pattern arrangement can in this case be larger than the polar angle of the position of the further starting reaction space.

For example, the reaction spaces of the array can be ordered first by the distance of a reaction space from a selected origin, and second by the polar angle in a coordinate system with the selected origin. The order of the reaction spaces can define the order of assignment of the specific reagents to the reaction spaces. In particular, for example, the reaction spaces can be ordered in a spiral. For this purpose, for example, a Cartesian coordinate system (x, y) can be defined with a given origin, for example the center of the array. Then, the distance from the origin r and the polar angle φᵢ of the positions (xᵢ, yᵢ) can be defined, where i can correspond to the number N of all reaction spaces kᵢ. In addition, each reaction space kᵢ of the pattern arrangement can be assigned an integer ordinal number within the interval [1, N], and the reaction spaces can be ordered according to the polar angle φ with the same distance from the origin, corresponding to kᵢ→ksᵢ for i=1 to N. In other words, in the selection of the other starting reaction space and the other starting reaction space, starting from the starting reaction space and including an increasing polar angle, a circular or spiral process can be performed around a center of the pattern arrangement. This has the advantage that, for example, in a substantially circular arrangement of reaction spaces, all target reagents can be distributed in an advantageous manner.

According to a further embodiment, a radius of the position of the starting reaction space in a selected polar coordinate system having an origin at the center of the pattern arrangement can be at least equal to a radius of the position of the further starting reaction space in a selected polar coordinate system having an origin at the center of the pattern arrangement. In particular, a radius of a position of another starting reaction space with respect to the selected polar coordinate system having an origin at the center of the pattern arrangement can in this case be larger than the radius of the position of the further starting reaction space. For example, in a pattern arrangement ordered according to a Cartesian coordinate system with a fixed origin, the distance from the origin rᵢ=√(xᵢ²+yᵢ²) and the polar angle φᵢ can be defined, where i can correspond to the number N of all reaction spaces kᵢ. Subsequently, each reaction space kᵢof the pattern arrangement can be assigned an integer ordinal number, and the reaction spaces can be ordered according to increasing distance from the origin r, corresponding to kᵢ→ksᵢ for i=1 to N. In other words, the starting reaction space, the further starting reaction space, and the other starting reaction space can be selected starting from a center of the pattern arrangement, each with a larger spatial distance from this center. In particular, when combining this approach with an increasing polar angle, the respective starting reaction space can thus be defined in an essentially spiral step sequence. This has the advantage that a particularly advantageous assignment of different specific reagents to the reaction spaces can be made and thus the degree of redundancy for the detection of the characteristics of the sample addressed by means of the specific reagents can be increased.

According to another embodiment, during the defining step, the first specific reagent can be defined to be the specific reagent of the starting reaction space if the first distance and the second distance are equal and if the first specific reagent has been used less than the second specific reagent so far throughout the pattern arrangement. Thus, when two specific reagents tⱼ and tₖ with j≠k are equally spaced, the sorting from the previous steps can be continued and the specific reagent tₖ of the specific reagents tⱼ₁ and tⱼ₂ can be selected which occurs last in the sorting, for example, for the second or third time. Advantageously, this can optimize a change in the assignment of the individual specific reagents to the reaction spaces over the entire pattern arrangement.

This method can, e.g., be implemented in software or hardware, or in a mixed form of software and hardware, e.g., in a control unit.

The approach presented herein also creates a carrier device, the carrier device comprising at least one specific reagent assigned to a reaction space of the carrier device according to the method described hereinabove. In particular, the carrier device can in this case be provided for a microfluidic analysis system, e.g., for a lab-on-chip cartridge, or be part of such an analysis system.

The approach presented herein furthermore creates an apparatus which is designed in order to perform, control, or change in corresponding devices the steps of a variant of a method presented herein. The object of the present invention can also be achieved quickly and efficiently by means of this embodiment of the invention in the form of an apparatus.

For this purpose, the apparatus can comprise at least one computing unit for processing signals or data, at least one storage unit for storing signals or data, at least one interface to a sensor or an actuator for reading sensor signals from the sensor or for outputting data or control signals to the actuator, and/or at least one communication interface for reading or outputting data embedded in a communication protocol. The computing unit can, e.g., be a signal processor, a microcontroller or the like, and the memory unit can be a flash memory, an EEPROM, or a magnetic memory unit. The communication interface can be designed to read or output data in a wireless and/or wired manner, in which case a communication interface capable of reading or outputting wired data can, e.g., electrically or optically read said data from a corresponding data transmission line or output the data in a corresponding data transmission line.

An apparatus is understood in the present case to mean an electrical device that processes sensor signals and outputs control signals and/or data signals as a function thereof. The apparatus can comprise an interface in the form of hardware and/or software. Given a hardware design, the interfaces can, e.g., be part of what is referred to as an ASIC system, which contains various functions of the apparatus. However, it is also possible that the interfaces be separate integrated circuits or consist at least in part of discrete components. Given a software design, the interfaces can be software modules provided on, e.g., a microcontroller in addition to other software modules.

A computer program product or a computer program comprising program code that can be stored on a machine-readable carrier or storage medium, e.g. a semiconductor memory, a hard disk memory or an optical memory and can be used for performing, implementing and/or controlling the steps of the method according to one of the above-described embodiments is advantageous as well, in particular when the program product or program is executed on a computer or an apparatus.

Exemplary embodiments of the approach presented herein are shown in the drawings and explained in greater detail in the description hereinafter. Shown are:

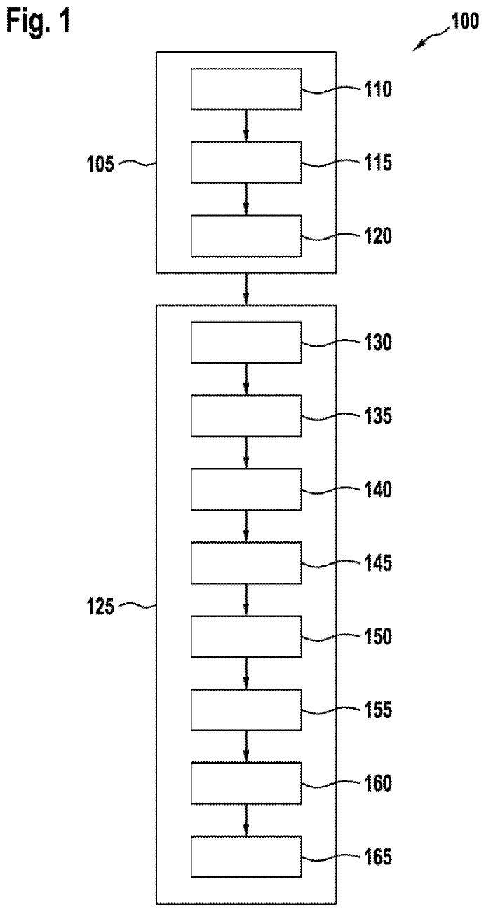

FIG. 1 a flowchart of a method according to an exemplary embodiment;

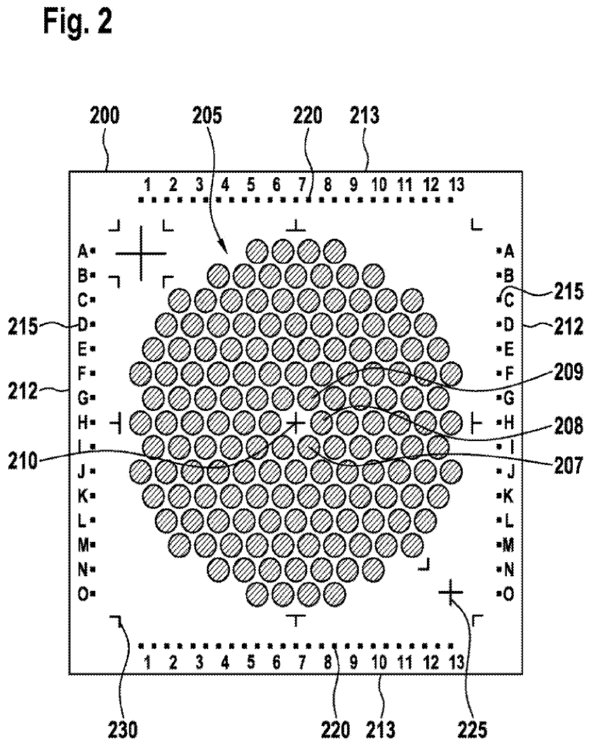

FIG. 2 a schematic top view of an exemplary embodiment of a carrier device with a spatial pattern arrangement of reaction spaces;

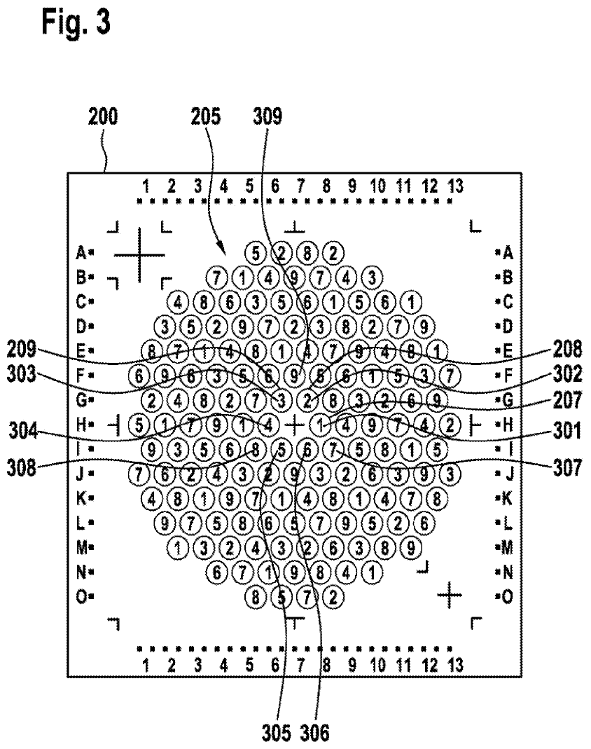

FIG. 3 a schematic top view of an exemplary embodiment of a carrier device with a spatial pattern arrangement of reaction spaces with specific reagents;

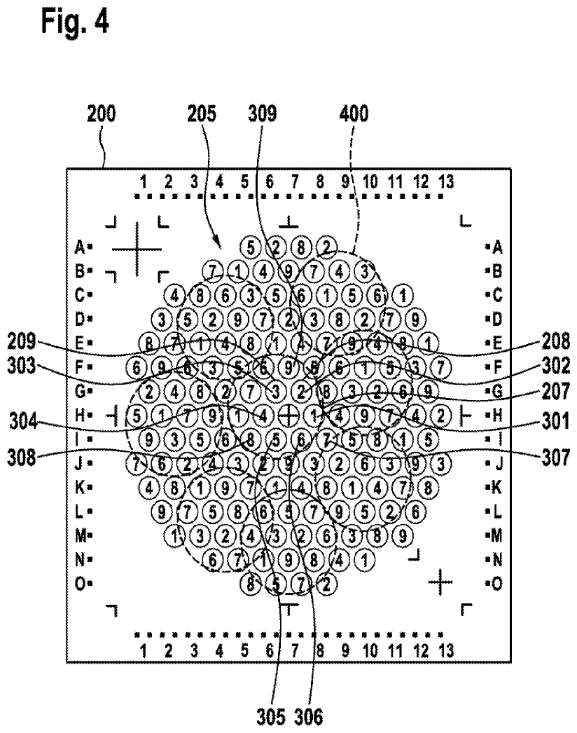

FIG. 4 a schematic top view of an exemplary embodiment of a carrier device with a spatial pattern arrangement with subsections;

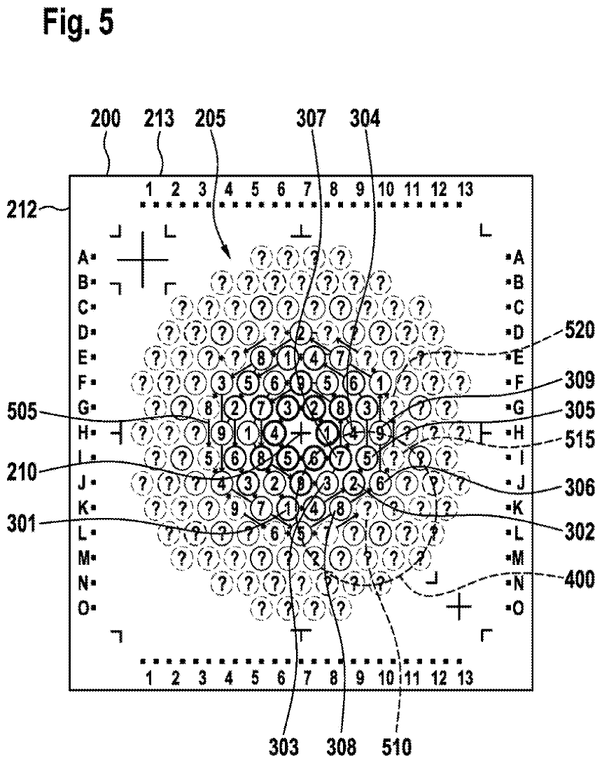

FIG. 5 a schematic top view of an exemplary embodiment of a carrier device with a spatial pattern arrangement;

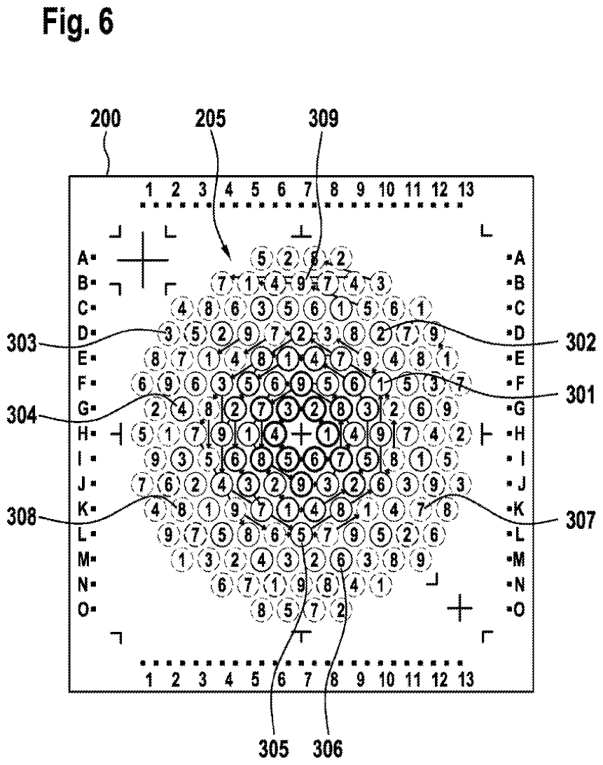

FIG. 6 a schematic top view of an exemplary embodiment of a carrier device with a spatial pattern arrangement; and

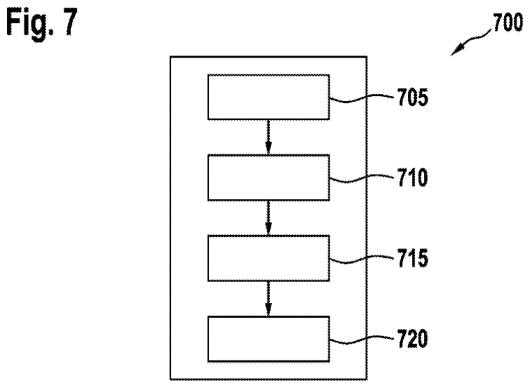

FIG. 7 a block diagram of an apparatus according to an exemplary embodiment.

In the following description of advantageous exemplary embodiments of the present invention, the same or similar reference signs are used for the elements shown in the various drawings and have a similar effect, whereby repeated description of these elements is omitted.

FIG. 1 shows a flowchart of a method 100 according to an exemplary embodiment. In this exemplary embodiment, the method 100 comprises a step 105 of ordering the reaction spaces. In step 105, only exemplary reaction spaces of the pattern arrangement, which can also be referred to as an array, are ordered. The reaction spaces are ordered, first, by the spatial distance of a reaction space from a selected origin of the pattern arrangement and, second, by the polar angle in a coordinate system with the selected origin. Thus, only an exemplary spiral arrangement of the reaction spaces takes place. To this end, the step 105 for ordering the reaction spaces in this exemplary embodiment comprises the substeps 110, 115, and 120 specified hereinafter.

In the substep 110 for defining an origin, in this exemplary embodiment, a Cartesian coordinate system (x, y) is defined with a predetermined origin, which is, e.g., merely the center of the pattern arrangement.

In the substep 115 for the distance definition, the distance from the origin rᵢ =(xᵢ²+yᵢ²) and the polar angle φᵢ of the positions (xᵢ, yᵢ) of the reaction spaces are defined, where the index i corresponds to a value between 1 and the number N of all reaction spaces kᵢ.

In the substep 120 for the assignment, each reaction space kᵢ of the pattern arrangement is assigned an integer ordinal number within the interval [1, N] and the reaction spaces are ordered, corresponding to kᵢ→ksᵢ for i=1 to N according to increasing distance from the origin r and according to the polar angle φ for equal distance.

In this exemplary embodiment, the step 105 of ordering the reaction spaces in the subsequent step 125 defines the order in which the specific reagents are assigned to the reaction spaces.

In step 125 of assigning the specific reagents to the reaction spaces, specific reagents that can be used for specific detection of features (targets, target molecules) of a sample are assigned to the reaction spaces of the pattern arrangement. In this exemplary embodiment, step 125 has substeps 130, 135, 140, 145, 150, 155, 160, and 165 described below.

In substep 130 of deciding on the specific reagents to be used, in this exemplary embodiment, the number n of specific reagents tⱼ to be distributed is determined at only three specific reagents as an example.

In substep 135 of the occupancy process, the n reaction spaces ksᵢ, for i=1to n, with the smallest ordinal numbers are assigned the n specific reagents tⱼ, for j=1 to n, by way of example only. Merely by way of example, the reaction spaces with the smallest ordinal numbers in this exemplary embodiment are arranged in the vicinity of the origin of the coordinate system, or in the central region of the array. Accordingly, in this exemplary embodiment, starting from the origin in a substantially spiral arrangement, a first specific reagent is assigned to a first reaction space, a second specific reagent is assigned to a second reaction space, and a third specific reagent is assigned to a third reaction space.

In the substep 140 for reading in, the spatial pattern arrangement of reaction spaces on the carrier device is read in, with the three specific reagents described in the previous step assigned to the corresponding reaction spaces, while no specific reagent has yet been assigned to the remaining reaction spaces.

In the substep 145 for determination, an starting reaction space is determined that does not yet have a specific reagent assigned to it. The starting reaction space can in this case also be referred to as the detection spot ksₙ₊₁ with ordinal number n+1.

In the substep 150 for measurement, a first spatial distance between the starting reaction space and the first reaction space, a second spatial distance between the starting reaction space and the second reaction space, and a third spatial distance between the starting reaction space and the third reaction space are measured. In other words, the distances d of the positions of all reaction spaces already assigned to specific reagents from the position of the starting reaction space are calculated.

In the substep 155 for sorting, the specific reagents tⱼ→tsⱼ are sorted according to increasing distance d of the assigned reaction spaces from the starting reaction space.

In the substep 160 for defining, the first specific reagent is defined to be the specific reagent of the starting reaction space because the first distance is greater than the second distance and greater than the third distance. For example, in another exemplary embodiment, the second specific reagent can be defined to be the specific reagent of the starting reaction space if the second distance is greater than the first distance and the third distance. Alternatively, in another exemplary embodiment, the third specific reagent can be defined to be the specific reagent of the starting reaction space if the third distance is greater than the first distance and the second distance. In other words, in the substep 160 for defining, the specific reagent t=tsₙ is assigned to the detection spot ksₙ₊₁, which has the largest distance d from the position of the detection spot ksₙ₊₁ or which occurs for the first time as the last in the list tsⱼ at the position j=n, respectively. In another exemplary embodiment, when two specific reagents are equally spaced, the sorting from substep 155 can continue and the specific reagent that occurs last in the sorting can be selected.

In summary, in substeps 145, 150, 155 and 160, the specific reagent tk is determined for the starting reaction space, which has the largest distance d from the position (xsₙ₊₁, ysₙ₊₁) of the starting reaction space.

In the substep 165 for repeating, in this exemplary embodiment, substeps 145, 150, 155, and 160 are repeated with n→n+1 multiple times until n=N−1, that is, until all reaction spaces of the pattern order are each assigned to a specific reagent. The assignment can in this case preferably also comprise, as explained hereinabove, an arrangement or placement of the specific reagent at the respective assigned reaction space.

FIG. 2 shows a schematic top view of an exemplary embodiment of a carrier device 200 having a spatial pattern arrangement 205. By way of example only, the pattern arrangement 205 comprises a number of 150 reaction spaces, with a first reaction space 207, a second reaction space 208, and a third reaction space 209 arranged near the center 210 of the pattern arrangement 205. The reaction spaces are shown in this drawing as black circles, which are arranged on a circular surface according to a hexagonal scheme and in their entirety form the pattern arrangement 205, which can also be referred to as an array. In the letter strips 215 arranged at two opposite edge regions 212 in this drawing, the letters “A” to “O” are arranged in alphabetical order, while in number strips 220 arranged at two other edge regions 213, the numbers “1” to “13”, are arranged according to size. In the embodiment shown herein, both the letter bars 215 and the number bars 220 serve to clearly designate the reaction spaces. The crosses 225 and other structures 230 are used merely as examples to spatially reference the reaction spaces of the pattern arrangement 205.

FIG. 3 shows a schematic top view of an exemplary embodiment of a carrier device 200 having a spatial pattern arrangement 205 with specific reagents 301, 302, 303, 304, 305, 306, 307, 308, 309. The latter can in this case, as described, be the carrier device having the pattern arrangement described in FIG. 2. In this exemplary embodiment, nine different specific reagents 301, 302, 303, 304, 305, 306, 307, 308, 309 are assigned to a total of 150 reaction spaces of the pattern arrangement 205 according to the method described in FIG. 1. The first specific reagent 301 is in this case assigned to the first reaction space 207, the second specific reagent 302 is assigned to the second reaction space 208, and the third specific reagent 303 is assigned to the third reaction space 209. Specific reagents 301, 302, 303, 304, 305, 306, 307, 308, 309 are identified by the numerals 1 through 9 (by way of example only). The assignment is in this case advantageously designed such that all features of a sample (targets, target molecules) to be detected by means of the specific reagents 301, 302, 303, 304, 305, 306, 307, 308, 309 occur in different subsections, as described in the following FIG. 4. of the pattern arrangement 205. In this exemplary embodiment, the pattern arrangement 205 has a regular, merely exemplary hexagonal arrangement of reaction spaces to minimize the size of the subsections each having all specific reagents 301, 302, 303, 304, 305, 306, 307, 308, 309 at least once.

FIG. 4 shows a schematic top view of an exemplary embodiment of a carrier device 200 having a spatial pattern arrangement 205 with subsections 400. This can be the carrier device described in FIG. 2 and FIG. 3 with the pattern arrangement described. Congruent to the exemplary embodiment described in FIG. 3, the reaction spaces of the pattern arrangement 205 in this drawing are also each assigned one of nine specific reagents 301, 302, 303, 304, 305, 306, 307, 308, 309. A first specific reagent 301 is thus assigned to the first reaction space 207, a second specific reagent 302 is assigned to the second reaction space 208, and a third specific reagent 303 assigned to the third reaction space 209. In this exemplary embodiment, all features of a sample (targets, target molecules) detectable by means of the specific reagents 301, 302, 303, 304, 305, 306, 307, 308, 309 are present at least once in a circular subsection 400 of the pattern arrangement 205, each subsection 400 being represented by a dashed line. The radius of each circular subsection 400 has a minimum value determined by the number of different specific reagents 301, 302, 303, 304, 305, 306, 307, 308, 309 and by the arrangement of the reaction spaces of the pattern arrangement 205. Accordingly, in this exemplary embodiment, the pattern arrangement 205 is characterized by the fact that already the evaluation of one of the subsections 400 is sufficient to analyze a sample for all features (targets, target molecules) addressed by means of the nine specific reagents 301, 302, 303, 304, 305, 306, 307, 308, 309.

FIG. 5 shows a schematic top view of an exemplary embodiment of a carrier device 200 having a spatial pattern arrangement 205. This can be the carrier device described in FIG. 2, FIG. 3, and FIG. 4 with the pattern arrangement described. In the embodiment shown in this case, only some of the reaction spaces near the center 210 already have specific reagents 301, 302, 303, 304, 305, 306, 307, 308, 309 assigned to them. The drawing shown in this case corresponds to performing the substep of repeating described in FIG. 1, that is, repeatedly performing the previous substeps for assigning the specific reagents to the reaction spaces. The previous steps have already been performed as shown schematically in the drawing shown herein:

In the ordering step, the reaction spaces of the pattern arrangement 205 were ordered starting from the cross-shaped reference mark at the center 210 of the pattern arrangement 205 in a spiral fashion with a counterclockwise orientation as indicated by the arrows 505. Subsequently, the number of specific reagents 301, 302, 303, 304, 305, 306, 307, 308, 309 to be distributed was determined at nine, which are represented by the numbers 1 through 9 in the schematic diagram (merely by way of example). An assignment of the specific reagents 301, 302, 303, 304, 305, 306, 307, 308, 309 to the first nine reaction spaces of the pattern arrangement 205 was then performed starting from the center 210. In this step, the specific reagents 301, 302, 303, 304, 305, 306, 307, 308, 309 were in particular assigned according to increasing value of the quantification.

Subsequently, a further assignment of the specific reagents 301, 302, 303, 304, 305, 306, 307, 308, 309 to the further reaction spaces of the pattern arrangement 205 has already taken place, whereby the substep, which comprises the repeated performance of the substeps for the assignment, is not yet fully completed in the embodiment shown herein. This is particularly evident from the reaction spaces of the pattern arrangement 205 arranged further towards the edge regions 212 and the other edge regions 213, to which no specific reagent is yet assigned. Accordingly, these reaction places are marked with a question mark.

In other words, in the present embodiment, the method is shown during the performance of the step of assigning a specific reagent to the starting reaction space 510, which can also be referred to as K9 and which is located in the center of the subsection 400 shown as a dashed circle. Starting from the starting reaction space 510, the following order of specific reagents 301, 302, 303, 304, 305, 306, 307, 308, 309, with duplicates, is obtained according to their spatial distance from the starting reaction space 510:

The specific reagents 308, 302, 306 numbered 8, 2, and 6 have the smallest distance from the starting reaction space 510 within the dotted circle. Specific reagents 303, 305 numbered 3 and 5 are arranged within the dashed circle, as are specific reagents 304, 307 numbered 4 and 7. Specific reagents 305, 309, 306, 304 numbered 5, 9, 6, 4 and 9 are arranged on the dotted circle and specific reagents 301 numbered 1 and 1 are arranged outside the dotted circle.

Consequently, the specific reagent assigned to a reaction space of the pattern arrangement 205, which has the largest spatial distance to the starting reaction space 510, is the specific reagent 301 with the number 1, since all other specific reagents 302, 303, 304, 305, 306, 307, 308, 309 with the numbers 2 through 9 are already assigned to reaction spaces of the pattern arrangement 205, which are arranged within the subsection 400 or on the dotted circle of the subsection 400 and thus have a smaller spatial distance to the position of the starting reaction space 510. Accordingly, the specific reagent 301 numbered 1 is assigned to the starting reaction space 510.

In a subsequent step not shown in this drawing, another starting reaction space 515 can be defined, as well as another starting reaction space 520. In the repetition of the described method steps, specific reagents 301, 302, 303, 304, 305, 306, 307, 308, 309 can also be assigned to the further starting reaction space 515 and the other starting reaction space 520.

FIG. 6 shows a schematic top view of an exemplary embodiment of a carrier device 200 having a spatial pattern arrangement 205. This can be the carrier device described in FIG. 2, FIG. 3, FIG. 4, and FIG. 5 with the pattern arrangement described. In the embodiment shown in this case, a specific reagent 301, 302, 303, 304, 305, 306, 307, 308, 309 is assigned to each reaction space according to the method described in FIG. 1. In a further advantageous exemplary embodiment, multiple specific reagents can also be assigned to each reaction space, or a specific reagent can address several subtargets or subfeatures, which can, e.g., be detected independently of each other.

FIG. 7 shows a block diagram of an exemplary embodiment of an apparatus 700. The apparatus 700 is designed to perform or cause to be performed the method of FIG. 1 or a similar method. The apparatus 700 comprises a unit 705 for controlling a reading in of a spatial pattern arrangement of the reaction spaces on the carrier device, and a unit 710 for controlling a determination of a starting reaction space to which no specific reagent is yet assigned. The apparatus 700 further comprises a unit 715 for controlling the measurement of a first spatial distance between the starting reaction space and the first reaction space and a second spatial distance between the starting reaction space and the second reaction space. In addition, the apparatus 700 comprises a unit 720 for controlling a definition of the first specific reagent as a specific reagent of the starting reaction space when the first distance is greater than the second distance and/or the second specific reagent as a specific reagent of the starting reaction space when the second distance is greater than the first distance.

If an exemplary embodiment comprises an “and/or” conjunction between a first feature and a second feature, then this is to be understood such that the exemplary embodiment according to one embodiment comprises both the first feature and the second feature and, according to a further embodiment, comprises either only the first feature or only the second feature.

1. A method for assigning at least one specific reagent to at least one reaction space of a carrier device for processing of a substance within a microfluidic analysis system, the method comprising:
reading in a spatial pattern arrangement of the reaction spaces on the carrier device, wherein at least a first reaction space is assigned a first specific reagent, and a second reaction space is assigned a second specific reagent;
determining a starting reaction space to which a specific reagent has not yet been assigned;
measuring a first spatial distance between the starting reaction space and the first reaction space and a second spatial distance between the starting reaction space and the second reaction space; and
defining the first specific reagent as the specific reagent of the starting reaction space if the first distance is greater than the second distance and/or defining the second specific reagent as the specific reagent of the starting reaction space if the second distance is greater than the first distance.

2. The method according to claim 1, wherein:
during the reading in step of the spatial pattern arrangement, a third specific reagent is assigned to a third reaction space,
the measuring includes comparing a third spatial distance between the starting reaction space and the third reaction space with the second distance and the first distance, and
the defining includes defining the third specific reagent to be the specific reagent of the starting reaction space if the third distance is greater than the second distance and the first distance.

3. The method according to claim 1, wherein different specific reagents of the at least one specific reagent are each assigned to a respective reaction space of the at least one reaction space prior to the reading in of the spatial pattern arrangement step.

4. The method according to claim 3, further comprising:
prior to the reading in of the spatial pattern arrangement, assigning a specific reagent of at least one specific reagent to a reaction space of at least one reaction space that has a greater distance from an edge region of the pattern arrangement than another reaction space of at least one reaction space.

5. The method according to claim 1, wherein the steps of the method are repeatedly performed for a further starting reaction space that is different from the starting reaction space.

6. The method according to claim 5, wherein a first polar angle of a first position of the starting reaction space in a selected polar coordinate system having an origin at a center of the sprial pattern arrangement is smaller than a second polar angle of a second position of the further starting reaction space with respect to the selected polar coordinate system having the origin at the center of the pattern arrangement.

7. The method according to claim 5, wherein a first radius of a first position of the starting reaction space in a selected polar coordinate system having an origin at a center of the pattern arrangement is at least equal to a second radius of a second position of the further starting reaction space in the selected polar coordinate system having an the origin at the center of the pattern arrangement.

8. The method according to claim 5, wherein, during the defining, the first specific reagent is defined to be the specific reagent of the starting reaction space if the first distance and the second distance are equal and if the first specific reagent has been used less than the second specific reagent so far over the entire pattern arrangement.

9. A carrier device for a microfluidic analysis system, the carrier device comprising:
the at least one specific reagent assigned to at least one reaction space of the carrier device according to the method of claim 1.

10. An apparatus comprising:
a reading unit configured to control a reading in of a spatial pattern arrangement of reaction spaces on a carrier device for processing of a substance within a microfluidic analysis system, wherein at least a first reaction space is assigned a first specific reagent, and a second reaction space is assigned a second specific reagent;
a determining unit configured to control a determination of a starting reaction space to which a specific reagent has not yet been assigned;
a measuring unit configured to control a measurement of a first spatial distance between the starting reaction space and the first reaction space and a second spatial distance between the starting reaction space and the second reaction space; and
a defining unit configured to control a definition of the first specific reagent as the specific reagent of the starting reaction space if the first distance is greater than the second distance and/or defining the second specific reagent as the specific reagent of the starting reaction space if the second distance is greater than the first distance.

11. A computer program configured to execute the method according to claim 1.

12. A non-transitory machine-readable storage medium on which the computer program according to claim 11 is stored.

13. The method according to claim 6, wherein a third polar angle of a third position of another starting reaction space with respect to the selected polar coordinate system having the origin at the center of the pattern arrangement is larger than the second polar angle of the position of the further starting reaction space.

14. The method according to claim 7, wherein a third radius of a third position of another starting reaction space with respect to the selected polar coordinate system with the origin in the center of the pattern arrangement is larger than the second radius of the position of the further starting reaction space.
